(19) United States
(12) Patent Application Publication
(10) Pub. No.: US 2012/0181791 A1
(43) Pub. Date: Jul. 19, 2012

(54) Captured wind energy (CWE)

(76) Inventor: Edward D. Rennar, Manahawkin, NJ (US)

(21) Appl. No.: 13/373,962

(22) Filed: Dec. 6, 2011

Related U.S. Application Data
(60) Provisional application No. 61/461,153, filed on Jan. 13, 2011.

(51) Int. Cl. F03D 9/00

(52) U.S. Cl. 290/55

(57) ABSTRACT

An improved system that will revolutionize the use of wind turbines, make them more aesthetically appealing to the public thus making it easy to obtain permits from the local authorities for residential, commercial and industrial uses. The system should start with at least 400 watt 12-24- or 48 volt output wind turbines. Thus the duct system would be around 4.3 foot diameter duct 21 with this size turbine or larger if the space in the area is adequate. The idea can be incorporated with a solar system to make it a hybrid system. Wind turbine companies will be anxious to obtain an idea of this kind. The United States has a wealth of innovation in its own citizens. This invention would benefit our way of life and our environment.

This application claims the benefit of provisional patent application Ser. No. 61/461,153, filed 2011 Jan. 13 by the present inventor.

### BACKGROUND

This relates to wind turbines being used in a way not to be seen by the human eye. Turbines have a notorious look about them to the public; my invention will provide a way in placing them in residential/commercial/industrial applications. A designed air scoop is placed on the roof similar to a cupola with weather vain. In turn, this scoop is connected to a duct which the wind is funneled into. In the duct, wind turbines are placed to accept this wind; these ducts are installed inside of a structure. The unique thing is that there may be as many as three placed in this duct system. The ability for power would be accomplished by the wind turbine generators being connected in an electrical setup mode. This scoop would be placed on a ball bearing-type collar to accept the wind in all directions with its rotation. The turbine generators would be stationary because there is no need for them to turn to the wind direction as the scoop would do that action, the wind force at times will get to dangerous points so I made the scoop react to this problem by folding back, by the use of a hinge and springs. The wind will exit through the duct where there is a ninety-degree wind exit vent. All sections of ductwork would be joined together in the direction of the wind exhaust; this will permit no obstruction of wind forces.

All joints would be screwed and taped together for a tight and rigid approach; weatherproof aluminum foil tape is recommended with weatherproof caulking for the joints. Enclosure for the turbine generators would come in sections with rubber boots to join each section and to access the unit for maintenance and installation. Straps to hold the ducting system off the floor would be anchored to the above wood joist and can be made of rubber or mesh, all to take up vibration and noise. A drain system would compensate for the water which comes in from the scoop and exits through a PVC pipe setup as shown in the drawings through the wall with a ninety-degree adapter. Optional: an electrical heating-type system using heat tape or wire which is used on roofs and gutters could be incorporated into the duct system for extreme weather conditions (blizzards, ice, etc.). This system can be plugged into a 110-volt outlet adapter with a remote control to turn it on. Complete duct system should have a pitch like a horizontal plumbing drain pipe to exit any moisture or water that would accumulate. If the exiting moisture or water cannot be pitched to the drain because of the inside structure then it can also be pitched to the exit of the duct system with another similar drain.

In conclusion, insofar as I am aware, no system has been devised to really allow turbines the freedom of access, maintenance and installation to them and invisibility status.

### SUMMARY

An improved way of using wind turbines without the visibility of the unit (turbine). My invention incorporates the look into the architecture of the building whether it is residential, commercial or industrial. The only thing that would be visible is the scoop which collects the wind and wind exit vent which harvests the wind through the turbines to produce electricity, thereby eliminating three or more turbines in a wind farm affect on a roof and getting a similar outcome. The building roof structure would require being at least 30 feet minimum height from the ground level and require that no trees or larger buildings be in close vicinity of said structure and availability of the inside roof structure space. Wind velocity should be appropriate for the area and measured for application. Appearance is more acceptable and could cut electric bill costs. Also, it is easy to access for maintenance and installation. Harm to bird life is not an issue as the bird guard screens eliminate that problem, plus local permits would be more likely to obtain.

I recommend coastal areas as the number one practical use and in Midwest states. Turbines have the advantage to be placed in this duct system which can be stationary because the scoop would do all the movement of the wind direction. The scoop bends back on springs to prevent wind from damaging the turbines and the scoop at gale force winds and will return to original position on which I have placed rubber bumpers on the scoop when it returns to its original position.

Accordingly, several advantages are to provide an improved wind turbine use system. The actual electrical hookup is not at this time discussed as wind turbines have already been around many years. Still further advantages will become apparent from a study of the following description and the accompanying drawings. My system has all the probabilities of also working in the new electric automobiles being designed. One reason is, instead of using gas generators to recharge the battery in the car, use my invention and incorporate it in a car design with some changes. As wind enters the auto in the front it can be a small open round cylinder with a door or slide-type, open and close to the wind rush and can in turn make small turbines charge the batteries, thus no gasoline needed and batteries get charged almost all the time. As the car goes faster, the door or slide will open or close to allow the right amount of wind rush to the turbines and not damage the turbines and produce necessary calculated voltage to charge the battery. Again, a heater can be incorporated to stop freezing in extreme conditions. Charging the car at stations can be eliminated altogether, thus less drain on the grid (green energy).

### DRAWINGS

### Figures

In the drawings, some closely related figures have the same number but different alphabetic suffixes.

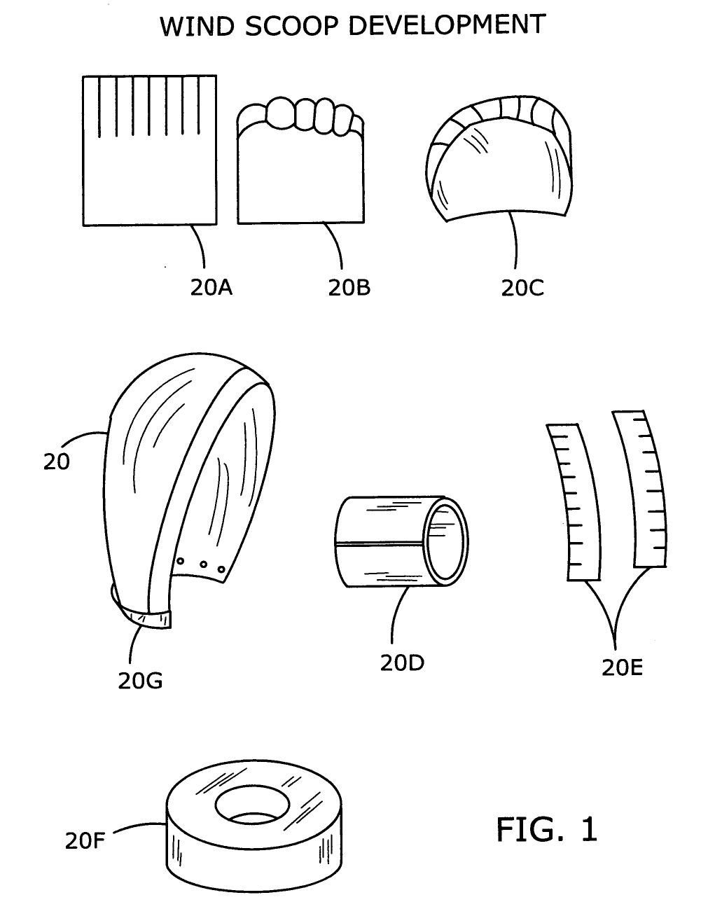

FIG. 1 is a perspective view of the top section (scoop) of my system showing how it is made and material parts 20A to 20G.

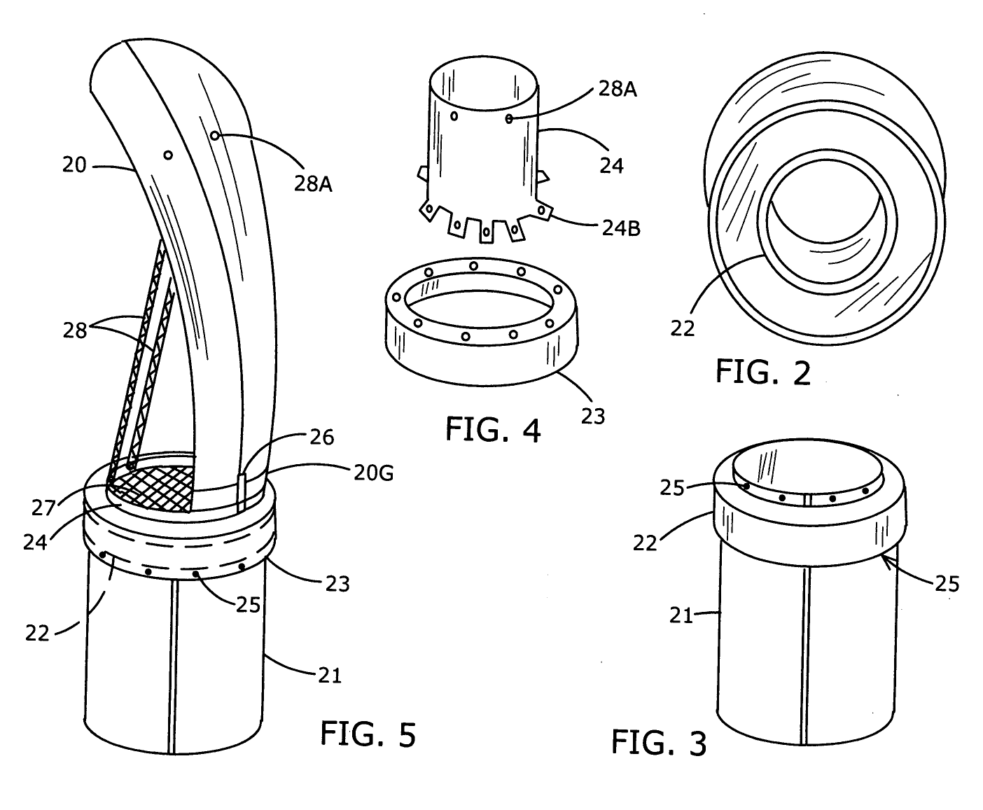

FIG. 2 is the bearing collar which the scoop will rotate on. It may be a sealed or open bearing.

FIG. 3 collar bearing mounted on starting duct, stopping sheet metal screws 25 to stabilize bearing collar. The screws 25 which stop the collar bearing from moving up and down, should be located at the very top of 21.

FIG. 4 this is the cap or cover, made of sheet metal which is assembled to fit on the bearing collar very tightly and may need some weatherproof regular duct tape around the bearing collar for a tight fit without any movement. The duct cap will need a hole to be cut to the size of the duct, and starting duct collar will screw down onto this cap, parts must be covered with weatherproof foil tape.

FIG. 5 is the actual scoop without the tail end. This part catches the wind force and transfers it through the duct. Springs are incorporated with the scoop and a hinge to support the scoop action. This action is designed for gale force winds which will blow the scoop away when too much wind is available; this action protects the scoop and turbines from damage. It will bend back to allow the gale force winds deflection on it and return to the original position. A chicken wire cover is placed in the duct and secured with sheet metal screws for bird intrusion. Screws must be placed in the duct cap cover bottom and under the bearing collar to hold the top section in place.

This will hold the entire upper scoop housing securely. These screws will not interfere with the bearing collar movement.

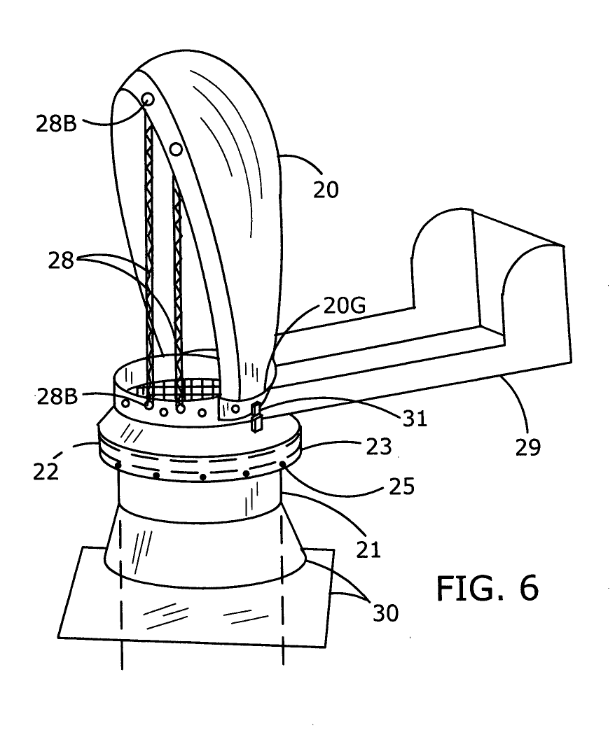

FIG. 6 again this is the actual close-up view of the scoop with its tail for guiding the rotation of the scoop to catch the wind hitting it. All around the cap cover of the bearing collar in FIG. 3 is placed weatherproof tin foil tap to cover and protect all exposed connections for weather purposes. A cupola-style adapter may be installed around the roof flange for decorative purposes. This cupola will start below the cap bearing cover to house the lower portion. The roof sheet metal flange will house the duct system start and is anchored to roof. It also will hold securely the entire upper portion of the scoop.

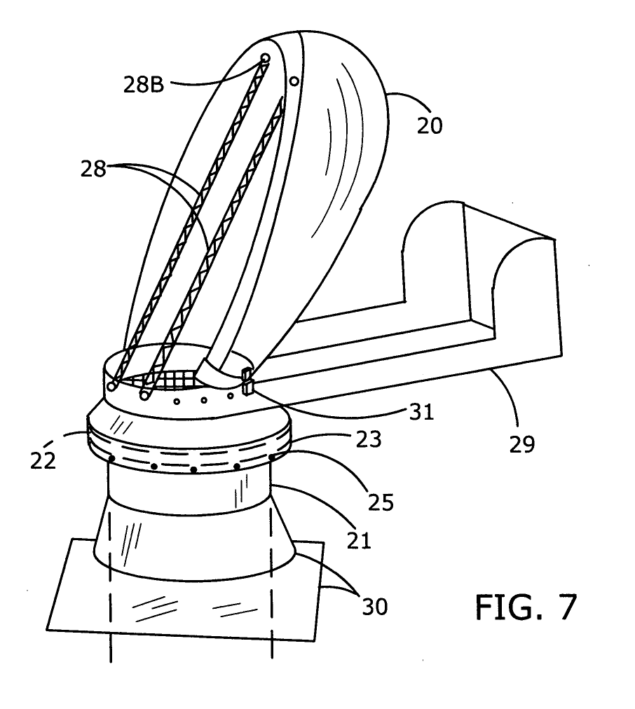

FIG. 7 the scoop deflected in the position that it is intended to do when high speed winds hit it. All the other parts have been discussed in previous figures.

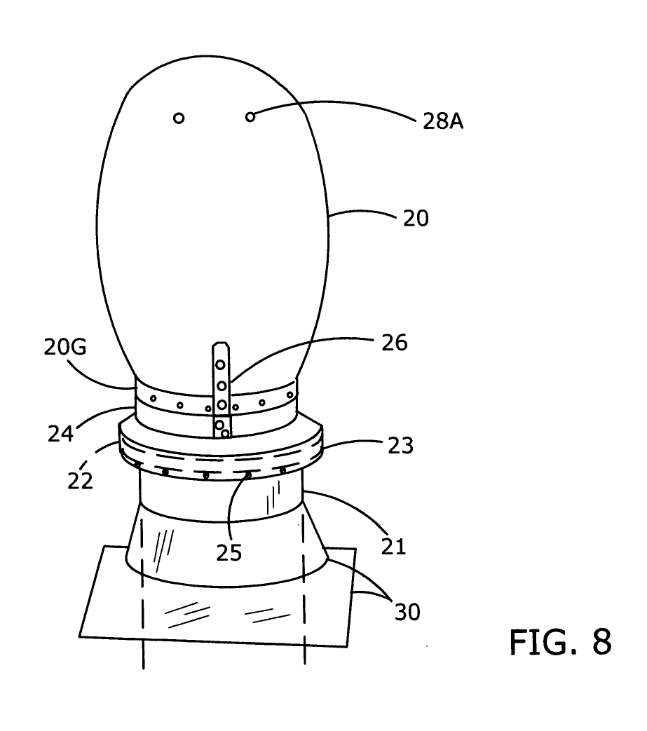

FIG. 8 this is the rear portion of the air scoop without the tail end.

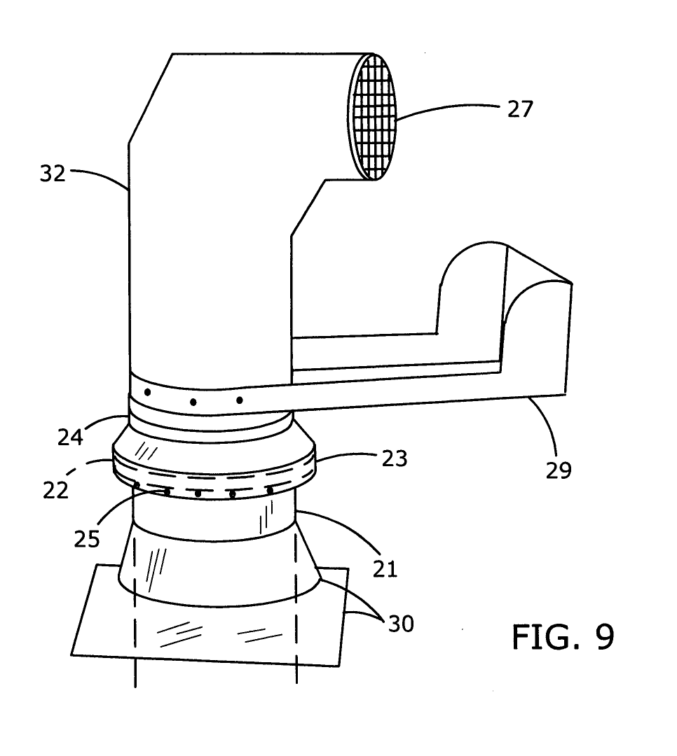

FIG. 9 is showing the end of the line exhaust vent. This is an exhaust vent with a bird guard, again chicken-style wire in the opening and vent made of sheet metal material. The end of the line is through the roof very similar to the air scoop set-up but there is no bending back to deflect the wind.

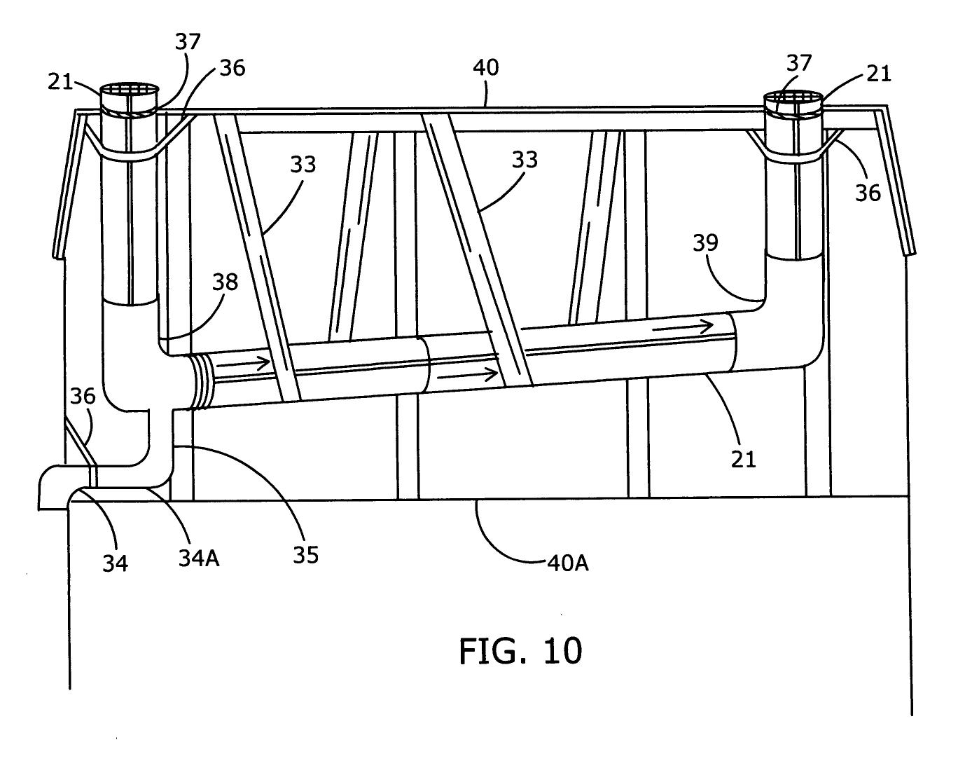

FIG. 10 is the inside of any location on a building at the roof top area with adequate space. No turbine sections are installed at this time. This shows a duct coming in the roof top area to a ninety-degree sheet metal elbow duct with a drain and another sheet metal elbow duct exiting connection from the main duct system with straps for securing the duct system. Rain water which enters the scoop will drain through a proper sized PVC plumbing system and exit a wall with a ninety-degree PVC adapter. The ducting system will be secured to a joist hook with mesh cloth or rubber straps, material specifically designed to take up noise and vibration of the turbines. Also a rubber gasket is needed where the duct enters and exits the roof. This gasket is for the noise and vibration of both unit rotations.

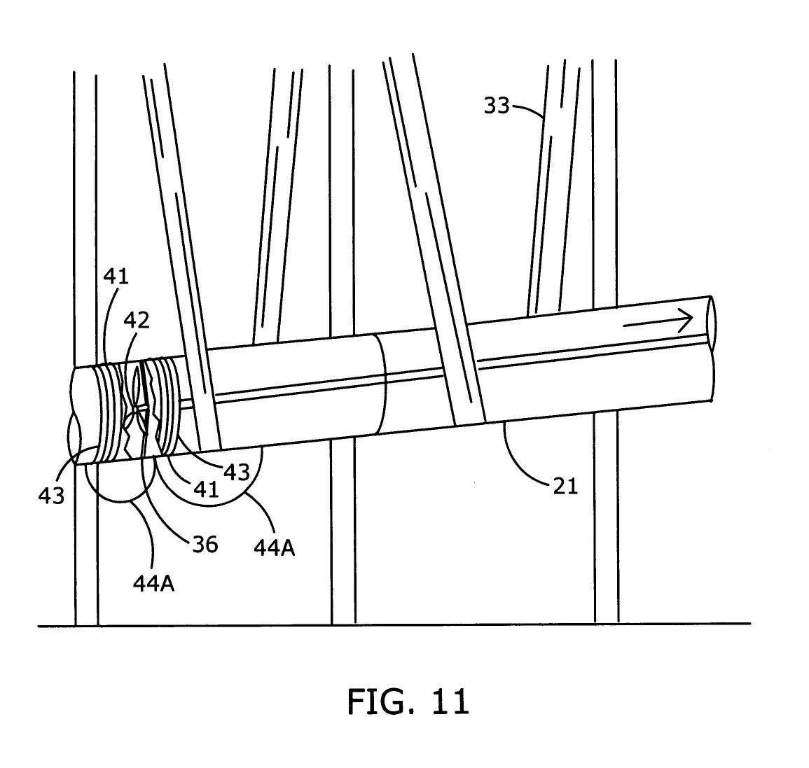

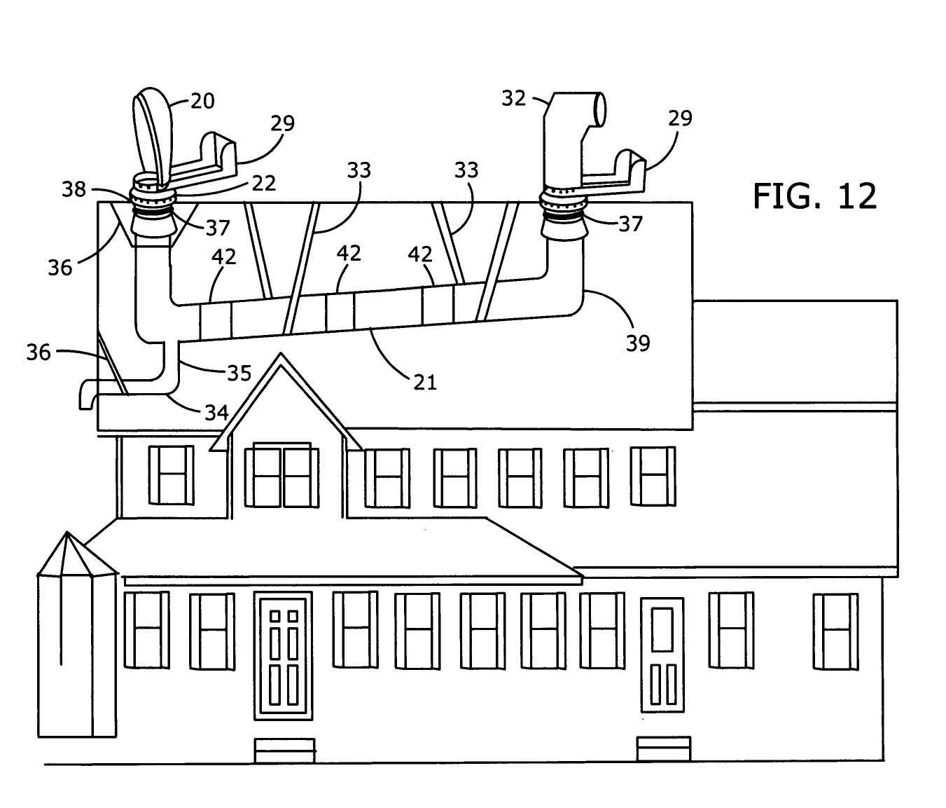

FIG. 11 inside area space with a turbine connected to produce energy. This turbine section is self-contained. There can be as many as three turbine sections hooked up. These sections are joined by a rubber boot on both sides of sections. Boots will have a strap on each side to which it is connected to and a total of four is needed. A bonding electrical jumper is installed to keep grounding continuity to all metal parts.

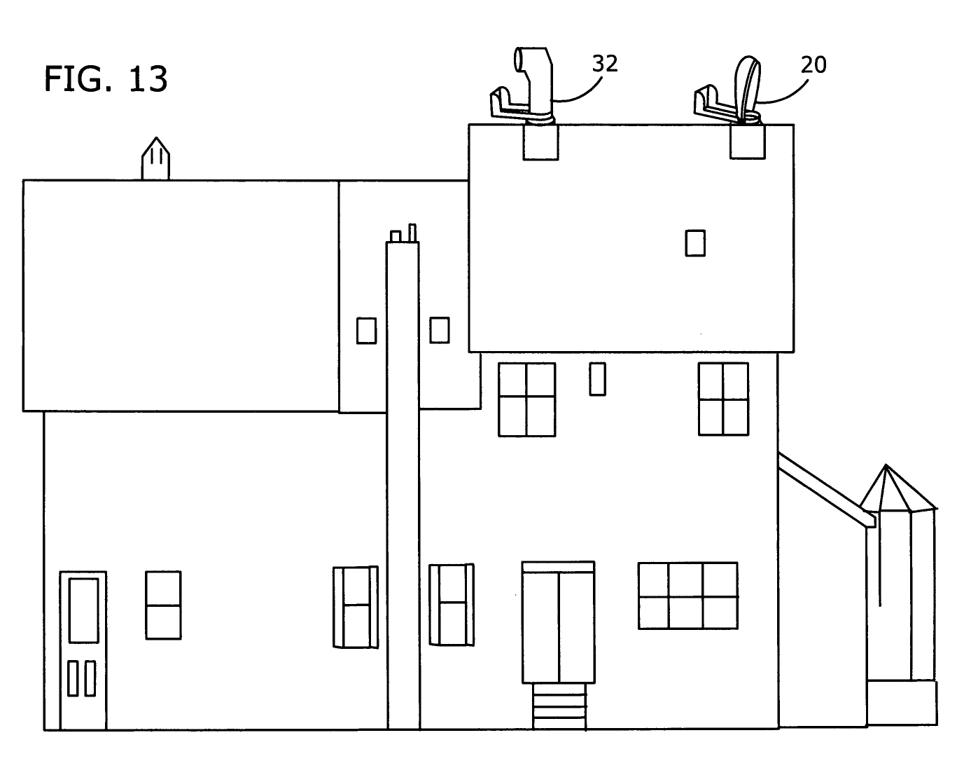

FIG. 12 is a residential view but can also be commercial or industrial. The front of a building structure showing the complete layout, inside view with all actual parts as is explained in detail description.

FIG. 13 is a rear view of the scoop and vent with a cupola style look.

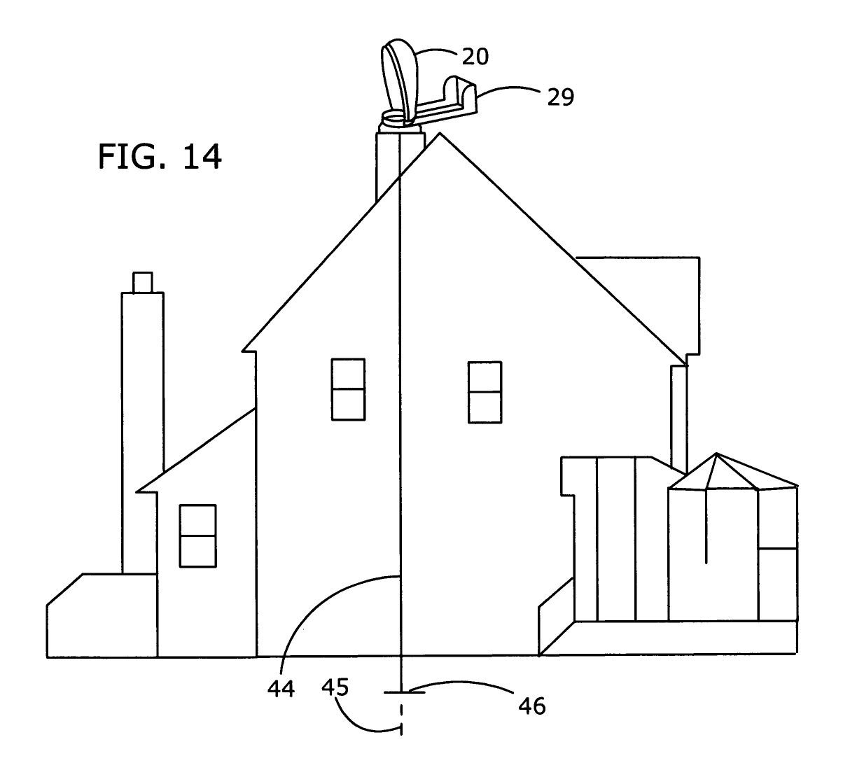

FIG. 14 is the left side of the building structure showing the scoop in a cupola-style setup on the rear roof side of the building. Protection from electrical strikes and damage is provided by an electrode to a ground rod.

### DETAILED DESCRIPTION

### FIGS. 1 to 14

FIG. 1 is a perspective view of the top portion material of my Captured Wind Energy system. 20 is sheet metal, thin gauge about 4′×4′ with cuts, which will enable a person to bend in a round scoop like position. 20B is showing the development stage. 20 is the desired finished form, 20G is a heavier gauge metal band to give the needed strength. This scoop will need 20F to hold in place to form design. 20D is a metal duct section which will need to be cut in half, 20E and formed around the sides of 20C, again with 20F. The size is in direct proportion with the other embodiments as we build.

FIG. 2 is a perspective view 22 of any open or closed type steel bearing size at this time is not necessary as the system can be designed to any given project; power and rotor blade diameter of the turbines which will be used dictates the size needed for the duct (diameter).

FIG. 3 the round sheet metal duct 21 will be the passageway for the wind. 22 are sized to the direct proportion of 21 diameter and in turn 21 is sized to the wind turbines rotor blade diameter. 25 sheet metal cutting screws on the top of 22 and under 22 installed onto 21 embodiment as needed. These are to stop 22 from any up or down movement and secure in place.

FIG. 4 is a view of a sheet metal duct cap cover 23 with a round hole cut in the middle in direct measurement to diameter of 21 and sized to fit on 22. Weatherproof regular duct tape is placed around 22 for a tight fit which is very important. 24 is a starting duct collar. 24B are the screw holes with which 24 is to be screwed to 23, again measurements are to follow 21 guide lines, 28A holes are to which springs will be attached. Parts 24 and 23 will be covered with 20F foil tape.

FIG. 5 20 is the top related main catcher of wind force (scoop). 28 helps 20 bend back to deflect high wind velocity and return. 26 hinge is needed to hold 20 for support and in place. The bird intrusion guard 27 is installed in the entrance; chicken wire can be used and secured with 25. 25 is also used to keep the top portion of completed scoop unit (20, 23, 24) in a secure and stable manner. Screws 25 are put on the bottom portion of 23 and under 22.

FIG. 6 top portion 20 with all parts ready. 29 tail wind guide, 31 are two rubber bumpers on each side to protect 20 on its return back to ready position. 20G is the heavy metal support band. 28B are four metal loop holders for 28.

FIG. 7 show 20 deflecting the high wind problem it may encounter and how it operates, this action protects 20 from damage and the turbines 42 from running out of control.

FIG. 8 is 20 rear view look without the tail 29.

FIG. 9 is another main embodiment 32 to which the wind must exit. This part 32 is guided by 29 in the opposite direction of 20 where the tail 29 is in the rear of 20. On 32 the tail 29 is positioned in the front. The wind will have a clear and free passageway with a continued draft affect. All lower parts of 20 and 32 are working in the same way and built the same; these parts are 21, 22, 23, 24, 25; 29 would be a little different, it would be lower so scoop 20 can have the bending back affect.

FIG. 10 an inside look into any given area in which my system can be installed, no turbines are installed at this time on my drawings. Two round holes would be cut into the roof section, one for the scoop 20 and the exhaust vent 32. 36 are braces/brackets for support and vibration awareness. 33 these are rubber or mesh holding support straps for the main duct 21. 34 is a PVC water drain pipe, 34A PVC elbows, 35 funnel or start drain, and 38 is the metal elbow duct with drain hole at the bottom for water runoff. 40 roof top and 40A floor of any given area to which system will be installed. 30 roof flashing adapter would be installed at this time. The main duct would have a pitch to the drain area 35 similar to a plumbing drain pipe. The duct system sections would come in a roll type section and then opened and snapped together to the diameter it was designed for.

It would be very similar to the sheet metal ducts that Home Depot stores would sell but on a much larger scale. This design would make installation much easier to work with. The duct would be no less than four feet in diameter and can be even ten feet in diameter for commercial and industrial projects which would have the capable space. All connection joints would be joined by using 25 sheet metal screws and caulked to leak proof and then wrapped with 20F. 39 elbow ninety degree section exit wind part.

FIG. 11 42 is a wind turbine generator installed in a section with 36 metal brackets supported in three places with 25. 41 are rubber boots that can be moved back to install these turbines and maintain with ease for access. The boots would have a band type squeeze connection 43. 44A is an electrical bonding jumper needed for turbine section continuity ground with a ground clamp.

FIG. 12 is the front view of any building structure with all the embodiments stated in my detailed description. This structure can be built new or can be existing to accommodate this system, whether it is residential, commercial, or industrial. I am showing a residential structure in my drawings.

FIG. 13 is a perspective view of the rear of a structure with a cupola design around it. 32 and 20.

FIG. 14 side view of structure with 44 earth grounding electrode, 45 ground rod, and 46 earth ground.

### DRAWINGS

### Reference Numerals

20A sheet metal with cuts
   B folding cut metal
   C further folds
   D round duct section
   E round duct section cut in half
   F air conditioning aluminum foil tape
   G metal reinforcement band
20 desired air scoop
21 round sheet metal duct
22 bearing collar
23 round metal duct cap
24 starting duct collar
25 sheet metal cutting screws
26 hinge
27 bird guard
28 springs
28A spring support holes
28B spring metal loop holders
29 tail wind guide
30 roof flashing adapter
31 rubber bumpers
32 wind exhaust vent elbow
33 rubber or mesh straps
34 PVC water drain
34A PVC elbow adapter
35 funnel
36 support bracket
37 rubber bumpers
38 inside start sheet metal duct elbow
39 inside exit sheet metal duct elbow
40 roof top
40A floor
41 rubber boot
42 wind turbine generator
43 metal support band
44 grounding electrode
44A bonding jumper
45 ground rod
46 earth ground

Operation

In operation, one uses the turbines 42 and the hookups electrically, as was always known and invented many years ago, but in my turbine system use you may combine a few for more power. Turbines, when installed in a series, position in a duct 21 can produce enough energy to lower your electric bills.
(1) Wind, when introduced into a duct system 21 will turn turbines. The scoop 20 which catches the wind force is the main distributor and part of the system.
(2) The scoop 20 will turn in any direction on a bearing collar 22.
(3) Exhausting the wind energy has the ability to turn turbines and exit itself through the exit vent 32, with a draft affect.
(4) Thus you have a (Captured Wind Energy) system that will work (CWE).

1. A new use or system of using wind turbines that are completely invisible to the human eye in a horizontal ducting system, as many as three to be connected electrically in a series style electrical connection to increase the power output.

2. Also giving my invention the ability to be more acceptable to local codes for permits, more easily maintained and more convenient to access the turbines, more appealing to the public and giving the user power to decrease local utility electric bills.

3. Also, this system can be designed exactly into a new structure blueprint or an existing structure with an easy construction design.
